(19) United States
(12) Patent Application Publication
(10) Pub. No.: US 2012/0211917 A1
(43) Pub. Date: Aug. 23, 2012

(54) Wafer Furnace with Variable Flow Gas Jets

(75) Inventors: Leo van Glabbeek, Franklin, MA (US); Lianghong Liu, Raleigh, NC (US); Weidong Huang, Bolton, MA (US); David Hitchcock, Westford, MA (US); Stephen Yamartino, Wayland, MA (US)

(73) Assignee: EVERGREEN SOLAR, INC., Marlborough, MA (US)

(21) Appl. No.: 13/032,742

(22) Filed: Feb. 23, 2011

(51) Int. Cl. B29C 39/14; B29C 51/42

(52) U.S. Cl. 264/164; 425/71

(57) ABSTRACT

A method of forming a sheet wafer 1) passes at least two filaments through a molten material to produce a partially formed sheet wafer, 2) directs a cooling fluid at a flow rate toward the partially formed sheet wafer to convectively cool a given portion of the partially formed sheet wafer, and 3) monitors the thickness of the given portion of the partially formed sheet wafer. To ensure appropriate thicknesses of the wafer, the method controls the flow rate of the cooling fluid as a function of the thickness of the given portion of the partially formed sheet wafer.

### TECHNICAL FIELD

The invention generally relates to sheet wafers and, more particularly, the invention relates to devices and processes for forming sheet wafers.

### BACKGROUND ART

Silicon wafers are the building blocks of a wide variety of semiconductor devices, such as solar cells, integrated circuits, and MEMS devices. For example, Evergreen Solar, Inc. of Marlboro, Mass. forms solar cells from silicon wafers fabricated by means of the well-known “ribbon pulling” technique.

The ribbon pulling technique uses proven processes for producing high quality silicon crystals. Such processes, however, may produce sheet wafers having relatively thin areas that are prone to breaking. For example, FIG. 1 schematically shows a cross-sectional view of a part of a prior art ribbon crystal 10A (also referred to as a growing “sheet wafer”). This cross-sectional view shows a so-called “neck region 12” that is thin relative to the thickness of the rest of the sheet wafer 10A.

To avoid this problem, conventional ribbon pulling furnaces may have meniscus shapers for varying the shape and height of the interface between the growing sheet wafer and the molten silicon, thus eliminating the neck region 12. Although beneficial for this problem, meniscus shapers necessarily must be cleaned at regular intervals to ensure appropriate furnace operation. Consequently, the entire crystal growth process must be suspended to clean the meniscus shapers, thus reducing yield. Moreover, meniscus shaper cleaning requires manual/operator intervention, thus driving up production costs.

To avoid these problems, certain ribbon pulling furnaces have included gas jets for directing a cooling fluid toward the thin neck region 12. See, for example, U.S. Pat. No. 7,780,782 for a furnace incorporating such gas jets.

### SUMMARY OF THE INVENTION

In accordance with one embodiment of the invention, a method of forming a sheet wafer 1) passes at least two filaments through a molten material to produce a partially formed sheet wafer, 2) directs a cooling fluid at a flow rate toward the partially formed sheet wafer to convectively cool a given portion of the partially formed sheet wafer, and 3) monitors the thickness of the given portion of the partially formed sheet wafer. To ensure appropriate thicknesses of the wafer, the method controls the flow rate of the cooling fluid as a function of the thickness of the given portion of the partially formed sheet wafer.

In addition to controlling wafer thickness, this method can aid in detecting error conditions within a wafer forming furnace. For example, the method may measure the flow rate of the cooling fluid from a given nozzle (delivering the fluid) and, using the measured flow rate, determine if an error condition exists. To that end, the method may use the thickness of the given portion of the wafer to determine if the error condition exists. Alternatively, or in addition, the method may control the flow rate of the cooling fluid as a function of the measured flow rate.

In response to detecting that the given portion has a thickness that is smaller than a first pre-set value, some embodiments may increase the flow rate of the given portion. This should increase the thickness at that point. In that case, among other things, the method may repetitively increase the flow rate at a prescribed incremental amount until the thickness reaches a prescribed value. In a corresponding manner, in response to detecting that the given portion has a thickness that is greater than a second pre-set value, the method may decrease the flow rate. This should reduce the thickness of the wafer at that point. Thus, in a manner similar to that discussed above, the method may repetitively decrease the flow rate at a prescribed incremental amount until the thickness reaches a prescribed value.

The given portion of the wafer illustratively is located between the edge of the wafer, and the longitudinal center of the wafer. Moreover, the cooling fluid may be directed in a given direction. To further control thickness, the method may direct the cooling fluid to another direction as a function of the thickness of the given portion of the partially formed sheet wafer. In a similar manner, the method may move the location of a nozzle delivering the gas as a function of the thickness of the given portion of the partially formed sheet wafer.

In accordance with another embodiment of the invention, a method of forming a sheet wafer 1) passes at least two filaments through a molten material to produce a partially formed sheet wafer, 2) directs a cooling fluid from a nozzle and toward the partially formed sheet wafer to convectively cool a given portion of the partially formed sheet wafer, and 3) monitors the thickness of the given portion of the partially formed sheet wafer. To control wafer thickness, the method also controls the position of the nozzle as a function of the thickness of the given portion of the partially formed sheet wafer.

In accordance with other embodiments of the invention, a wafer furnace has a crucible (for containing molten material) having pair of holes for receiving filaments, a gas jet positioned longitudinally above the crucible, and a fluid source coupled with the gas jet for providing fluid to the gas jet. The gas jet is configured to emit the fluid onto a growing sheet wafer formed from the filaments and molten material in the crucible. In addition, the furnace also has a thickness detector, positioned longitudinally above the crucible, that is configured to detect the thickness of a growing sheet wafer extending from the crucible. The thickness detector thus is configured to produce a thickness signal having thickness information relating to the thickness of the growing wafer. To control wafer thickness, the furnace also has a flow controller, operatively coupled with both the fluid source and the thickness detector, configured to control the flow of fluid from the source and toward the gas jet as a function of the thickness information in the thickness signal.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a partial cross-sectional view of a prior art ribbon crystal/sheet wafer.

FIG. 2 schematically shows a top view of a sheet wafer that may be produced in accordance with illustrative embodiments of the invention.

FIG. 3 schematically shows a cross-sectional view of the sheet wafer of FIG. 2 across line 3-3.

FIG. 4 schematically shows a portion of a ribbon crystal/sheet wafer furnace implementing of illustrative embodiments of the invention.

FIG. 5 schematically shows a sheet wafer in the process of being formed.

FIG. 6 shows a partial process of forming a sheet wafer in accordance with illustrative embodiments of the invention.

### DESCRIPTION OF ILLUSTRATIVE EMBODIMENTS

In illustrative embodiments, a method and apparatus monitor the thickness of a growing sheet wafer and vary the flow rate of a cooling fluid, directed toward the wafer, as a function of the thickness. More specifically, the method and apparatus may increase the flow rate of the fluid if the wafer is too thin, consequently thickening the wafer. Conversely, the method and apparatus may decrease the flow rate of the fluid if the wafer is too thick, consequently thinning the wafer. Other embodiments may redirect the path of the cooling fluid as a function of the thickness. Details of illustrative embodiments are discussed below.

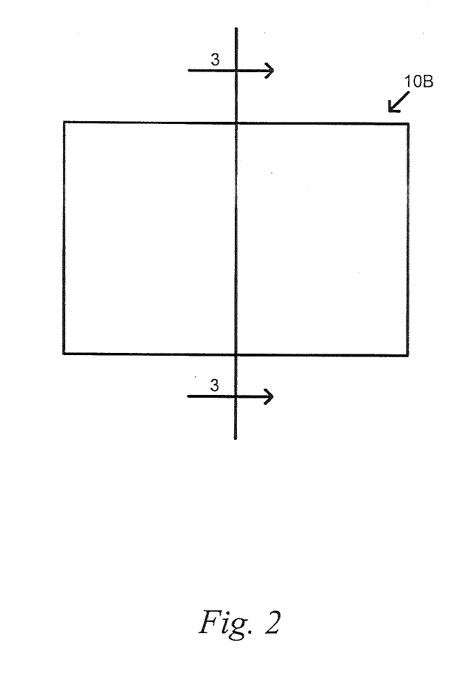

FIG. 2 schematically shows a sheet wafer 10B configured in accordance illustrative embodiments of the invention. In a manner similar to other sheet wafers, this sheet wafer 10B has a generally rectangular shape and a relatively large surface area on its front and back faces. For example, the sheet wafer 10B may have a width of about 3 inches, and a length of 6 inches.

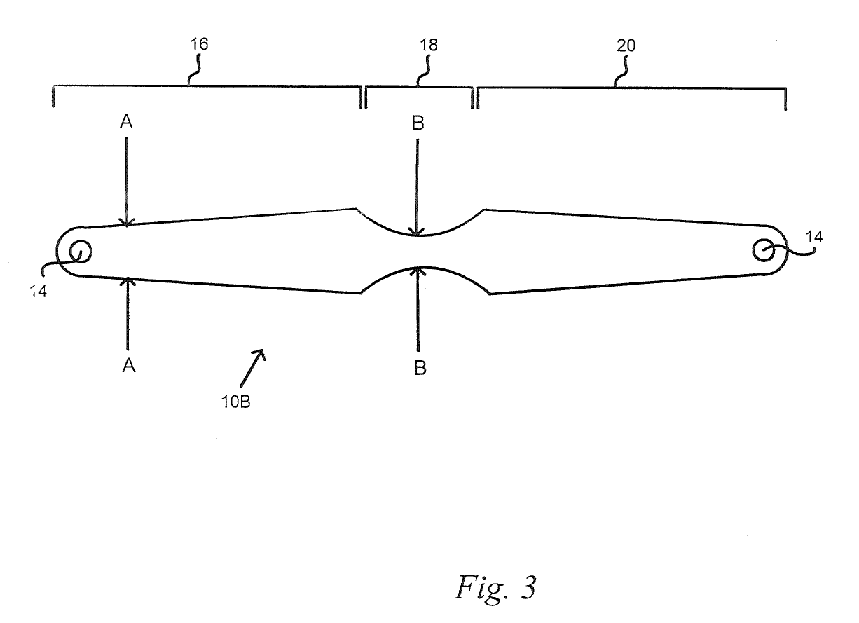

As known by those skilled in the art, the length of the wafer 10B can vary significantly depending upon where an operator chooses to cut the sheet wafer 10B as it is growing. In addition, the width of the wafer 10B can vary depending upon the separation of its two filaments 14 (see FIG. 3). For example, the wafer 10B can have a width of 156 mm, the industry standard for photovoltaic cells. Accordingly, discussion of specific lengths and widths are illustrative and not intended to limit various embodiments the invention. In addition, the thickness of the sheet wafer 10B varies and is very thin relative to its length and width dimensions.

More specifically, FIG. 3 schematically shows a cross-sectional view of the sheet wafer 10B of FIG. 2 across line 3-3. As a preliminary matter, it should be noted that FIG. 3 is not drawn to scale. Instead, it should be considered a schematic drawing for descriptive purposes only. In particular, the sheet wafer 10B is formed from a pair of filaments 14 encapsulated by silicon (e.g., multicrystalline silicon, single crystal silicon, or polysilicon). Although it is surrounded by silicon, the filament 14 and the silicon outwardly of the filament 14 generally form the edge of the sheet wafer 10B. In some embodiments, either or both of the filaments 14 form the relevant wafer edge.

The sheet wafer 10B also may be considered to have three contiguous portions; namely, a first end section 16 having a first filament 14 through it, a middle section 18, and a second end section 20 having a second filament 14 through it. The first and second end sections 16 and 20 may be referred to as “wafer edges 16 or 20.” In illustrative embodiments, the middle section 18 makes up about seventy-five percent of the total length of the sheet wafer 10B. The middle section includes the longitudinal center of the wafer 10B (i.e., the center of its width) The first and second end sections 16 and 20 thus together make up about twenty-five percent of the total length of the sheet wafer 10B.

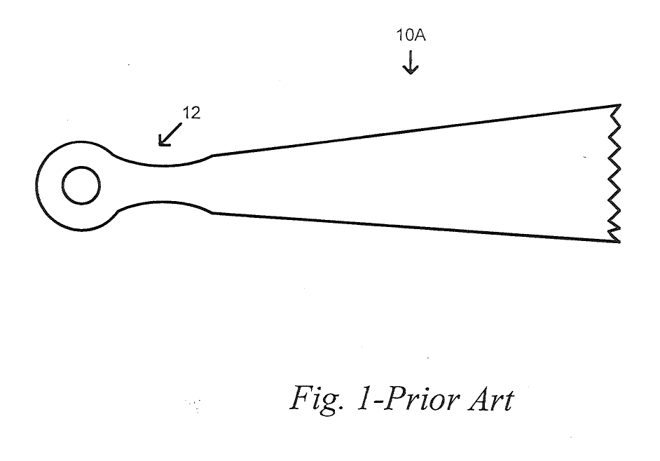

As shown, the thickness of the sheet wafer 10B generally increases when traversing from the edge of the first end section 16 to the boundary of the first end section 16 and the middle section 18. The thickness then begins to decrease until about the general center of the middle section 18, and then increases from the general center of the middle section 18 to the boundary of the middle section 18 and the second end section 20. In a manner similar to the first end section 16, the thickness of the sheet wafer 10B generally increases when traversing from the edge of the second end section 20 to the boundary of the second end section 20 and the middle section 18. Consequently, neither end section 16 or 20 has a fragile neck 12, such as that shown in FIG. 1.

As an example, the sheet wafer 10B may be considered to have a first portion generally identified in FIG. 3 between arrows A-A (i.e., within the first section), and an inner portion similarly identified in FIG. 3 between arrows B-B (i.e., within the middle section 18). The first portion A-A, which is between the edge and the inner portion B-B, has a greater thickness than that of the inner portion B-B. For example, the first portion A-A may have a thickness of about 200-250 microns (or about 250-350 microns), while the inner portion B-B may have a thickness of about 100-200 microns. Of course, different portions of the sheet wafer 10B may have similar relationships similar to the relationship between portions A-A and B-B. For example, another portion near the sheet wafer edge 16 or 20 may have a greater thickness than some more inward portion.

It should be noted that discussion of the relative thicknesses, dimensions, and sizes are illustrative and not intended to limit all embodiments of the invention. For example, the thickness of the end sections 16 and 20 may be substantially constant, while the middle section 18 increases. As another example, subject to manufacturing tolerances, the thickness may be substantially uniform across the entire sheet wafer 10B, or the thicknesses may be alternatively larger and smaller within one of the sections 16, 18, or 20, or more than one of the sections 16, 18 and 20. As yet another embodiment, the two end sections together could make up more than half of the total length of the sheet wafer 10B, while the middle section 18 makes up less than half of the total length of the sheet wafer 10B.

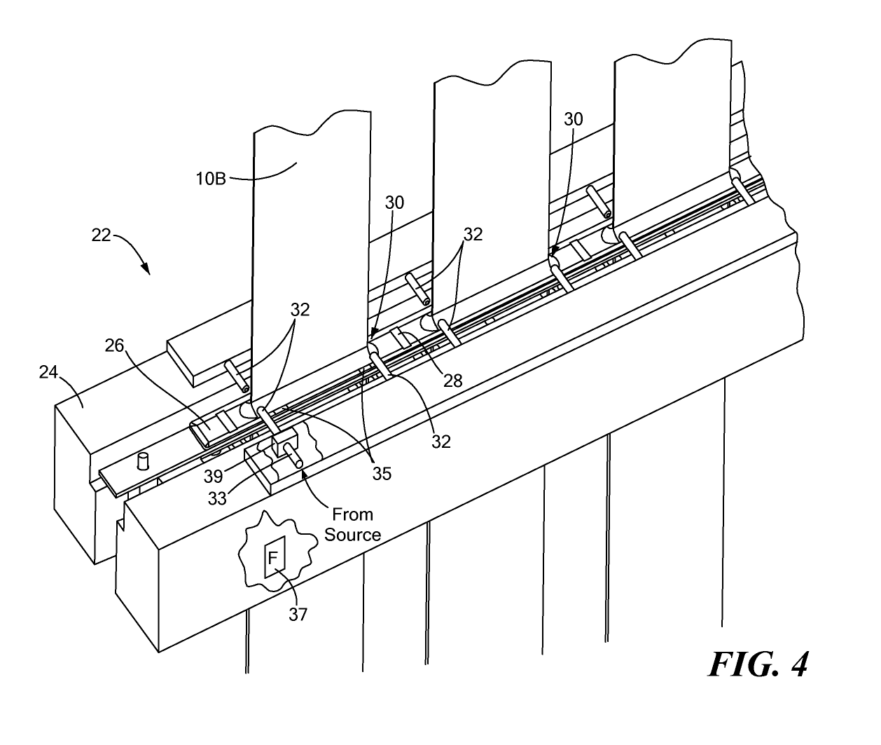

Illustrative embodiments may use the furnace 22 shown in FIG. 4 to produce the sheet wafer 10B shown in FIGS. 2 and 3. FIG. 4 schematically shows this furnace 22 while in use and thus, shows molten silicon and a sheet wafer 10B being pulled from the molten silicon. Specifically, the furnace 22 shown in FIG. 4 has a support structure 24 that supports a crucible 26 containing the noted molten silicon. In addition, the furnace 22 also may have a plurality of cooling bars 28 that provide some radiative cooling effect. The cooling bars 28 are optional and thus, may be omitted from the furnace 22.

The crucible 26 forms multiple pairs of filament holes 30 (only one of which is identified by reference number 30) for receiving high temperature filaments 14 that ultimately form the edge area of growing silicon sheet wafers 10B. For example, the crucible 26 shown has multiple pairs of filament holes 30 (e.g., three pairs of filament holes 30 shown) to grow multiple sheet wafers 10B simultaneously.

Among other things, the crucible 26 may be formed from graphite and preferably is resistively heated to a temperature capable of maintaining the molten silicon above its melting point. Moreover, the crucible 26 shown in FIG. 4 has a length that is much greater than its width. For example, the length of the crucible 26 may be three or more times greater than its width. Of course, in some embodiments, the crucible 26 is not elongated in this manner. For example, the crucible 26 may have a somewhat square shape, or a nonrectangular shape.

In accordance with illustrative embodiments, the furnace 22 has the capability of (locally) cooling the growing sheet wafer 10B in a manner that substantially eliminates the fragile neck 12 problem discussed above with regard to FIG. 1. Specifically, the furnace 22 has a cooling apparatus that locally cools specific portions of the growing sheet wafer 10B (e.g., the first and/or second end sections 16 and 20), thus effectively increasing its thickness in those areas.

To that end, similar to U.S. Pat. No. 7,780,782, the inventors used convection cooling techniques to accomplish this goal. More particularly, the molten silicon typically is maintained at a very high temperature, such as at temperatures that are greater than about 1420 degrees C. For example, the molten silicon may be maintained at a temperature between about 1420 degrees C. and 1440 degrees C.

Convective cooling suffices in this case because, among other reasons, each cooling apparatus cools only a very small portion of the growing sheet wafer 10B. The total mass of such small areas correspondingly is very small and yet, compared to its thickness, has a relatively large surface area. Accordingly, given these conditions, convective cooling could suffice for the desired application.

Accordingly, to that end, the embodiment shown in FIG. 4 has a plurality of gas nozzles 32 (hereinafter “jets 32”) for generally directing a gas toward a distinct portion of the growing sheet wafer 10B. The gas jets 32 illustratively are formed from graphite to withstand the high temperatures, and receive their gas from a source (shown schematically with arrows) through an interconnect (e.g., a stainless steel pipe 33, one of which is shown in the cut away of FIG. 4).

As shown, each growing sheet wafer 10B has two associated pairs of gas jets 32. One pair of gas jets 32 cools the first end section 16 of the sheet wafer 10B, while the second pair of gas jets 32 cools the second end section 20 of the sheet wafer 10B. Each jet 32 in a pair illustratively cools opposite sides of substantially the same portion of the sheet wafer 10B. Accordingly, the jets 32 in each pair shown in FIG. 4 direct gas flow in generally parallel but opposite directions. For example, the gas stream of one jet 32 in a pair may be generally coaxial with the gas stream produced by the other jet 32 in its pair (although the two streams do not mix due to the separation provided by the growing sheet wafer 10B).

To improve control of the cooling function, the gas jets 32 preferably provide substantially columnar gas flow to the sheet wafer 10B. To that end, illustrative embodiments use a relatively long tube relative to the inner diameter of its inner bore. For example, the ratio of the length of the tube to its inner diameter may be on the order of 10 or greater. The tube thus may have a substantially constant inner diameter of about 1 millimeter, and a length of about 12 millimeters.

The gas jets 32 may have different configurations. For example, rather than having pairs of gas jets 32, with one of the pair on each side of the wafer 10B, alternative embodiments may cool only one side of the growing sheet wafer 10B with a single gas jet 32. Other embodiments may have plural gas jets 32 or plural pairs of jets 32 cooling a single region of the growing sheet wafer 10B.

The gas streams illustratively each directly strike a relatively small part of the sheet wafer 10B. In fact, this relatively small part may be much smaller than the entire section/portion intended to be cooled, such as the first end section 16. For example, the general center of the columnar gas stream could be aimed to contact the sheet wafer 10B about 1 millimeter inwardly from the crystal edge, and about one millimeter above the interface of the molten silicon and the growing sheet wafer 10B (discussed below and identified by reference number 34). Contact with this relatively small part, however, may increase the temperature of the gas to some extent, but not necessarily eliminate its subsequent cooling effect.

Accordingly, after striking this small part of the sheet wafer 10B, the gas migrates to contact another part of the sheet wafer 10B, thus also cooling that other part by design. Eventually, the gas dissipates and/or the remaining gas heats up to a temperature that no longer has the ability to cool the sheet wafer 10B. The gas thus may be considered to form a cooling gradient as it contacts the sheet wafer 10B. Accordingly, by way of example, the gas jets 32 may cool substantially the entire first end section 16 of the sheet wafer 10B with both this primary and secondary cooling effect.

The total size of the area being cooled depends upon a number of different factors. Among others, such factors may include the gas flow rate, gas type, jet 32 size, speed of the growing crystal 10B, temperature of the molten silicon, and the location of the gas jets 32.

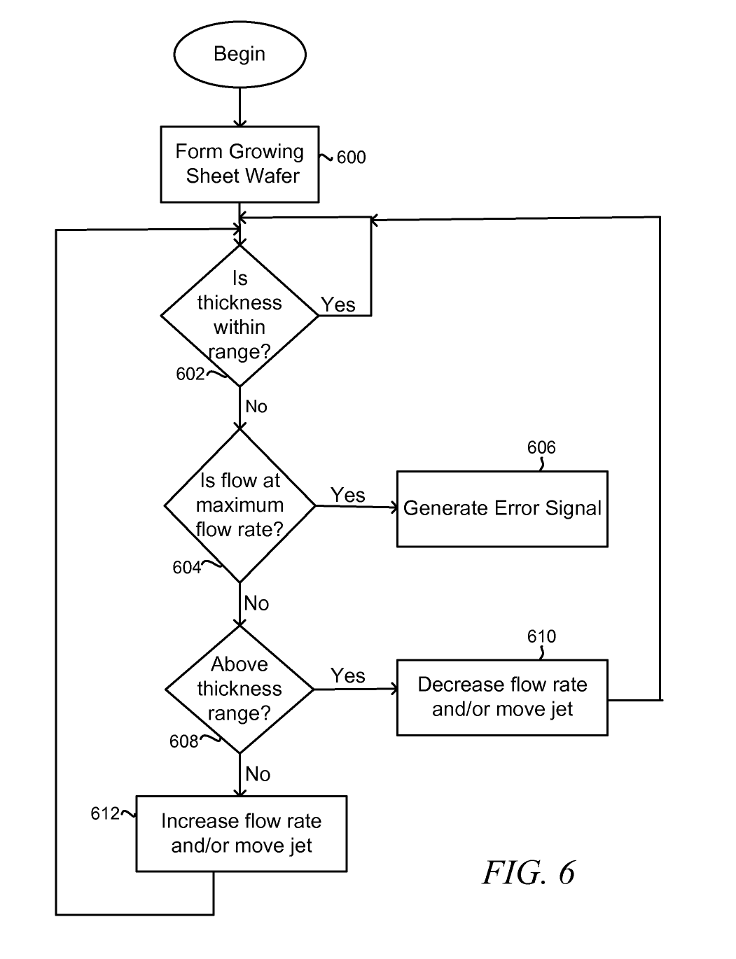

Illustrative embodiments can use any of a number of types of gases and flow rates to control the localized thickness of the growing sheet wafer 10B. For example, some embodiments use argon gas (i.e., a fluid) flowing at an initial cumulative flow rate (i.e., all jets 32) of up to 40 liters per minute (discussed in greater detail below with reference to FIG. 6). The flow rate should be determined based upon a number of factors, including the distance from the outlet of the jet 32 to the growing sheet wafer 10B, the desired cooling area of the sheet wafer 10B, the mass of the growing sheet wafer 10B, and the temperature of the gas. One skilled in the art should be mindful, however, to ensure that the flow rate is not so high that it could damage the growing sheet wafer 10B. Accordingly, although a higher flow rate may improve cooling in certain circumstances, it possibly can damage the sheet wafer 10B.

Moreover, in the above example, the argon gas may be emitted from the jet 32 at a temperature between 100 and 400 degrees C. (e.g., 200 degrees C.). Of course, other gases having other characteristics may be used. Accordingly, discussion of argon and specific temperatures should not limit various aspects of the invention.

In addition to convectively cooling the growing sheet wafer 10B, the gas jets 32 itself also may act as a source of radiative cooling. Specifically, in illustrative embodiments, the gas jets 32 are formed from material that effectively acts as a heat sink. For example, as noted above, the gas jets 32 may be formed from graphite. Accordingly, when positioned in relatively close proximity to the growing sheet wafer 10B, the graphite gas jet 32 material locally absorbs heat, thus furthering the cooling effect on the desired part of the growing sheet wafer 10B. Each gas jet 32 therefore may be considered as providing two sources of cooling; namely, convective cooling and radiative cooling.

In alternative embodiments, however, the gas jets 32 are not formed from a material capable of radiatively cooling the growing sheet wafer 10B. Instead, the jets 32 may be formed from a material that provides no greater than a negligible cooling effect on the growing sheet wafer 10B.

It should be noted that the specific gas jets 32 can be placed in any number of different locations. For example, rather than (or in addition to) positioning them to cool part or all of the first and second end sections 16 and 20, the gas jets 32 also may be positioned to cool part or all of the middle section 18. As another example, as noted above, the furnace 22 may have more gas jets 32 on one side of the sheet wafer 10B than on the other side of the sheet wafer 10B. The nature of the application and desired result thus dictates the number and position(s) of the gas jets 32.

The crucible 26 may be removable from the furnace 22. To do so, when the furnace 22 is shut down, an operator may simply lift the crucible 26 vertically from the furnace 22. To simplify removal, the gas jets 32 preferably are horizontally spaced from the vertical plane of the crucible 26 to facilitate that removal. For example, if the crucible 26 has a width of about 4 centimeters, then the gas jets 32 of a given pair are spaced more than about 4 centimeters apart, thus providing sufficient clearance for easy crucible removal.

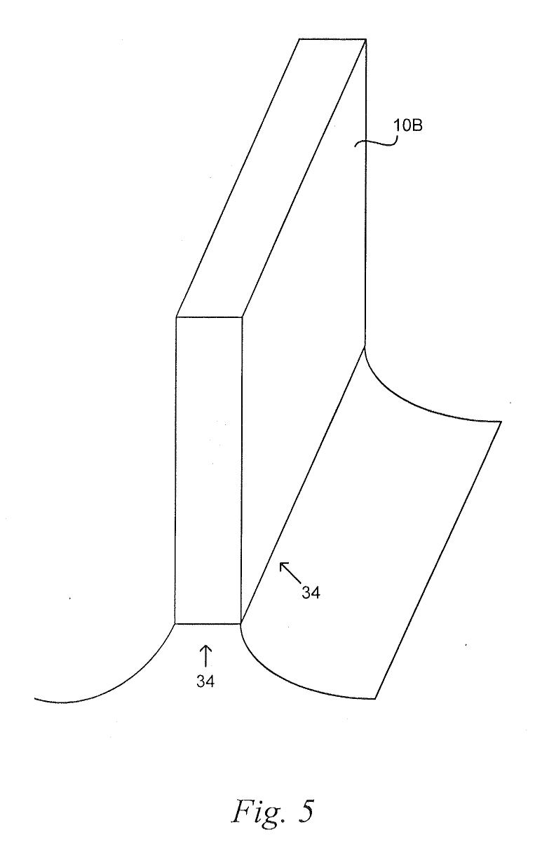

Moreover, the vertical position of each gas jet 32 impacts sheet wafer 10B thickness. Specifically, as background, the point where the growing sheet wafer 10B meets the molten silicon often is referred to as the “interface.” As shown in FIG. 5, the interface 34 effectively forms the top of a meniscus extending vertically upwardly from the top surface of the molten silicon. The height of the meniscus impacts sheet wafer thickness. In particular, a tall meniscus has a very thin thickness at its top when compared to the thickness at the top of a shorter meniscus.

As known by those skilled in the art, the thickness at and near this area determines the thickness of the growing sheet wafer 10B. In other words, the thickness of the growing sheet wafer 10B is a function of the location or height of the interface 34. As also known by those skilled in the art, the temperature of the region around the meniscus controls meniscus/interface 34 height. Specifically, if the temperature of that region is cooler, the meniscus/interface 34 will be lower than if the temperature is warmer.

Accordingly, the cooling effect of the gas jets 32 directly controls the height of the meniscus, which consequently controls the thickness of the growing sheet wafer 10B. The furnace 22 thus is configured to control the system parameters, such as gas flow rate, temperature the gas flow, spacing of the gas jets 32, etc. . . . , to control the height of the interface 34. This can be varied, either during growth, or before beginning the growth process, to vary the location of the interface 34.

In some embodiments, the gas jets 32 may be movable. For example, the gas jets 32 may be fixedly positioned, but pivotable in one or both the X and Y directions. Among other things, the jets 32 may be movable relative to the horizontal and/or the vertical. As another example, the gas jets 32 may be slidably connected to move horizontally along the furnace 22. In illustrative embodiments, the gas jets 32 also may be movable toward or away from the wafer 10B to facilitate cooling.

The above noted patent, however, generally discusses cooling the growing sheet wafer 10B with local convective cooling. The inventors discovered, however, that the furnace 22 should have further controls to improve its performance. Specifically, as the industry drives down the thickness of wafers, they become much more fragile. For example, many wafers have edges that are less than 350 microns thick (e.g., 300 microns, 250 microns, etc. . . .). This requires more precision in tuning or controlling their thicknesses in specific local regions. If too thin, they may break easily, significantly reducing yield. If too thick, the separation devices, such as downstream lasers, may not adequately separate or cut the growing wafer 10B. Moreover, silicon prices significantly impact cost and thus, additional, unnecessarily thick wafers 10B are commercially undesirable.

After attempting other solutions that did not yield good results, the inventors discovered that varying the convective cooling effect of the gas jets 32 as a function of the thickness of the growing wafer 10B solved their edge thickness problem. This technique produced better wafers 10B. In fact, it could be done on the fly, virtually immediately, in a close loop feedback system. For example, a first embodiment varies the flow rate of the cooling gas from the jets 32 as a function of the wafer thickness. Thus, the jets 32 can deliver more gas when the wafer 10B (portion) is too thin, and less gas when the wafer 10B is too thick. Other embodiments have movable gas jets 32 and, consequently, move or aim them differently as a function of the wafer thickness. For example, the jets 32 may be moved to different locations within the furnace 22, angled differently to cool a different part of the wafer 10B, and/or moved closer to/further away from the growing wafer 10B.

To that end, the furnace 22 has thickness detectors 35 that continually measure and monitor the thickness of the relevant portion of the growing sheet wafer 10B, and a flow controller 37 (shown in a partially cut-away portion of FIG. 4) that controls fluid flow through the jets 32 as a function of the detected thickness. These components preferably are connected in a closed loop system to ensure a tight integration and rapid response.

Among other things, the flow controller 37 can comprise logic specifically configured for this function. For example, the flow controller 37 can include one or all of a microprocessor executing program code, an application-specific integrated circuit (an “ASIC”), analog circuitry, and other hardware to control/meter flow of the gas from the gas source. This flow controller 37 also can include logic, or cooperate with external logic, that automatically moves the jets 32 as a function of wafer thickness.

Many types of thickness detectors 35 can provide satisfactory results. For example, one thickness detector 35 that should provide satisfactory results has a light emitting diode on one side/face of the sheet wafer 10B, and a sensor on the opposite side/face of the sheet wafer 10B. The thickness of the sheet wafer 10B is related to the amount of the diode light emitted through the sheet wafer 10B. Thus, the sensor detects the light through the wafer 10B and consequently determines wafer thickness at that point.

As discussed below, the wafer growth process also can benefit by measuring the gas flow directly from the jet 32. Accordingly, the furnace 22 also has flow meters 39 (one of which shown in one of the partial cut away portions of FIG. 4) for measuring gas flow from the jets 32. The flow meters 39 can be located near the outlets of the jets 32 themselves (either inside or outside of the jets 32). Alternatively, if the jets 32 are porous (e.g., graphite), the flow meters 39 near the jet outlets may not provide a good reading. Thus, some embodiments position the flow meters 39 just upstream of the jets 32-within the piping 33. By measuring gas flow directly into the jets 32, the process can detect error conditions and fine tune the thickness of the wafer 10B. Moreover, accurately measuring the gas flow permits the process to set and confirm the initial flow rate of the gas through the jets 32, as well as record/log the flow rate through the jets 32 at various times for error correction and performance review purposes (among others).

FIG. 6 shows a process of growing the sheet wafer 10B in accordance with illustrative embodiments of the invention. It should be noted that this process shows a few of the many steps of forming the sheet wafer 10B. Accordingly, discussion of this process should not be considered to include all necessary steps, or could be executed in a different order, if necessary. Moreover, although discussing a single wafer 10B, this process also applies to processes growing multiple sheet wafers 10B in parallel.

The process begins at step 600, which forms the growing sheet wafer 10B as shown in FIG. 5. To that end, a pair of filaments 14 are continually moved longitudinally through the filament holes 30 in the crucible 26 to form the interface 34 noted above. As the wafer 10B grows, separation processes remove the top portion at specific intervals to produce complete wafers 10B. The thickness detector 35 continually monitors the thickness of the edge portions 16 and 20, causing various responsive actions as discussed below with respect to step 602-612.

Specifically, the process determines at step 602 if the thickness of each wafer edge portion 16 or 20 is within a pre-set thickness range. For example, this range can be between about 200 and 300 microns, between about 250 and 350 microns, or some other range. More particularly, the flow controller 37 may have logic set to trigger certain responsive actions if either of the edge portion thickness is larger or smaller than pre-set values. For example, if the pre-set range is 200-250 microns, then step 602 determines if each of the edges is less than 250 microns thick and greater than 200 microns thick.

If the thicknesses are within the pre-set range, then the process merely continues to check the thickness. Conversely, if the thickness of at least one of the edges is outside of the range, then at least one edge is too thin or too thick. For simplicity, the rest of this process is discussed as having only one edge outside of the range. Those skilled in the art should understand, however, that this process applies to all regions of the wafer 10B being monitored (i.e., in this example, the two edges). For example, one edge may be too thick, while the other edge may be too thin. Those skilled in the art can implement the remaining steps to handle that and other conditions not addressed in detail. Discussion of a single edge thus is not intended to limit various embodiments of the invention.

The flow controller 37 then determines, at step 604 in conjunction with the relevant local flow meter 39, if the gas flow to either of the relevant jets 32 (i.e., the pair of jets 32 for that edge 16 or 20) is at a maximum flow rate. More specifically, gas can damage the growing wafer 10B if its flow rate is too high. Additionally, an error condition can exist within the system if the thickness is below the range and the gas is flowing at the maximum flow rate. For example, the gas line/pipe 33 connecting the source to the jets 32 can have a leak.

Accordingly, if the flow is at the maximum flow rate, the process may generate an error signal (step 606). Among other things, this error signal can include one or more of audible and visual indicia. In some embodiments, the process stops until the error condition is remedied. Other embodiments, however, may simply continue the process with the error condition.

If the flow is not at the maximum flow rate, however, then step 608 determines if the wafer thickness at the wafer edge 16 or 20 exceeds the thickness range. If so, then step 610 takes action to reduce the edge thickness. One potential action is to decrease the flow rate to one or both of the gas jets 32 at the thick wafer edge 16 or 20. For example, the flow controller 37 can reduce the cooling at that edge by reducing the flow rate of gas through one or both of its local gas jets 32.

The process can reduce the flow rate to the relevant jet(s) in a number of ways. For example, the flow controller 37 can simply reduce the flow rate by a preset incremental amount, and then loop back to step 602. Thus, the process can repetitively reduce the flow rate a set incremental amount until the thickness is at within prescribed thickness range. Alternatively, the process can continually reduce the flow rate until the thickness detector 35 determines that the thicknesses is within the range. For example, again using the above noted range of about 200-250 microns, the flow controller 37 can gradually reduce the flow rate, either continuously or in increments, until the thickness of the relevant edge portion is less than above 250 microns. To provide reasonable tolerances, step 610 could continue reducing gas flow until the thickness is about 225 microns.

Alternatively, or in addition, step 610 may physically move the jet(s) to reduce the thickness. For example, position logic (not shown) within the furnace 22 can automatically move the jets 32 farther away from the wafer 10B. The process also may direct the gas in a different direction by angling the jets 32 in a manner that reduces their cooling effect. In yet other embodiments, this step also can increase the temperature of the gas.

Returning to step 608, if the thickness of the edge is not above the range (and yet out of the range), then it is too thin, consequently requiring more cooling. The process thus continues to step 612, which takes action to increase the edge thickness. One potential action is to increase the flow rate to one or both of the gas jets 32 at the thin wafer edge 16 or 20. For example, the flow controller 37 can increase the cooling at that edge 16 or 20 by increasing the flow rate of gas through one or both of its local gas jets 32. The process can increase the flow rate in a manner analogous to the ways discussed above for decreasing the flow rate.

Alternatively, or in addition, in an analogous manner to that of step 610, step 612 may physically move the jet(s) to increase the thickness. For example, position logic (not shown) within the furnace 22 can automatically move the jets 32 closer to from the wafer 10B, and/or angle the jets 32 in a manner that increases their cooling effect. In yet other embodiments, this step also can reduce the temperature of the gas.

The processes described in FIG. 6 can be fully automated. Some embodiments, however, provide manual overrides to enable an operator to control various of the noted functions, such as flow rate, jet position, and gas temperature.

Accordingly, illustrative embodiments of the invention fine tune the wafer growth process by more precisely controlling wafer edge thickness. The resulting wafers 10B thus should not consume an excess amount of molten material and yet be less fragile. In addition, since the wafer edge 16 or 20 should have a more predictable thickness from wafer-to-wafer, downstream processing equipment, such as lasers tuned to specific edge thicknesses, should operate more efficiently, improving yields.

Although the above discussion discloses various exemplary embodiments of the invention, it should be apparent that those skilled in the art can make various modifications that will achieve some of the advantages of the invention without departing from the true scope of the invention.

What is claimed is:

1. A method of forming a sheet wafer, the method comprising:
passing at least two filaments through a molten material to produce a partially formed sheet wafer;
directing a cooling fluid at a flow rate toward the partially formed sheet wafer to convectively cool a given portion of the partially formed sheet wafer;
monitoring the thickness of the given portion of the partially formed sheet wafer; and
controlling the flow rate of the cooling fluid as a function of the thickness of the given portion of the partially formed sheet wafer.

2. The method as defined by claim 1 wherein the cooling fluid is directed by at least one nozzle, the method further comprising:
measuring the flow rate of the cooling fluid by a given nozzle of the at least one nozzle; and
using the measured flow rate to determine if an error condition exists.

3. The method as defined by claim 2 wherein using comprises using the thickness of the given portion of the wafer to determine if the error condition exists.

4. The method as defined by claim 2 further comprising controlling the flow rate of the cooling fluid as a function of the measured flow rate.

5. The method as defined by claim 1 further comprising:
detecting that the given portion has a thickness that is smaller than a first pre-set value; and
increasing the flow rate of the given portion in response to detecting that the given portion is smaller than the first pre-set value.

6. The method as defined by claim 5 wherein increasing comprises repetitively increasing the flow rate at a prescribed incremental amount until the thickness reaches a prescribed value.

7. The method as defined by claim 1 further comprising:
detecting that the given portion has a thickness that is greater than a second pre-set value; and
decreasing the flow rate if the thickness of the given portion is thicker than the second pre-set value.

8. The method as defined by claim 7 wherein decreasing comprises repetitively decreasing the flow rate at a prescribed incremental amount until the thickness reaches a prescribed value.

9. The method as defined by claim 1 wherein the wafer has an edge and a longitudinal center, the given portion being between the edge and the longitudinal center of the wafer.

10. The method as defined by claim 1 wherein the given portion has a thickness that is less than about 250 microns.

11. The method as defined by claim 1 wherein the cooling fluid initially is directed in a given direction, the method directing the cooling fluid to another direction as a function of the thickness of the given portion of the partially formed sheet wafer.

12. The method as defined by claim 1 wherein a nozzle initially directs the cooling fluid toward the partially formed wafer, the method subsequently moving the location of the nozzle as a function of the thickness of the given portion of the partially formed sheet wafer.

13. A method of forming a sheet wafer, the method comprising:
passing at least two filaments through a molten material to produce a partially formed sheet wafer;
directing a cooling fluid from a nozzle and toward the partially formed sheet wafer to convectively cool a given portion of the partially formed sheet wafer;
monitoring the thickness of the given portion of the partially formed sheet wafer; and
controlling the position of the nozzle as a function of the thickness of the given portion of the partially formed sheet wafer.

14. The method as defined by claim 13 wherein controlling comprises moving the nozzle either closer to or farther away from the wafer.

15. The method as defined by claim 14 further comprising:
detecting that the given portion has a thickness that is smaller than a first pre-set value; and
moving the nozzle closer to the given portion of the wafer in response to detecting that the given portion has a thickness that is smaller than the first pre-set value.

16. The method as defined by claim 14 further comprising:
detecting that the given portion has a thickness that is greater than a second pre-set value; and
moving the nozzle away from the given portion of the wafer in response to detecting that the given portion has a thickness that is greater than the second pre-set value.

17. The method as defined by claim 13 wherein controlling comprises changing the angle of the nozzle relative to the horizontal.

18. The method as defined by claim 13 wherein controlling comprises both changing the angle of the nozzle relative to the horizontal, and moving the nozzle either closer to, or farther away from, the growing wafer.

19. A wafer furnace comprising:
a crucible having pair of holes for receiving filaments, the crucible being configured for containing molten wafer material;
a gas jet positioned longitudinally above the crucible;
a fluid source coupled with the gas jet for providing fluid to the gas jet, the gas jet being configured to emit the fluid onto a growing sheet wafer formed from the filaments and molten material of the crucible;
a thickness detector positioned longitudinally above the crucible, the thickness detector being configured to detect the thickness of a growing sheet wafer extending from the crucible, the thickness detector being configured to produce a thickness signal having thickness information relating to the thickness of the growing wafer; and
a flow controller operatively coupled with the fluid source and the thickness detector, the flow controller being configured to control the flow of fluid from the source and toward the gas jet as a function of the thickness information in the thickness signal.

20. The furnace as defined by claim 19 wherein the pair of holes through the crucible are spaced a distance apart to define a general mid-point therebetween, the gas jet being positioned closer to one of the holes than to the mid-point.

21. The furnace as defined by claim 19 wherein the nozzle is movably positioned longitudinally above the crucible.

22. The furnace as defined by claim 21 wherein the pair of holes effectively forms a wafer plane extending generally perpendicular to the crucible, the nozzle being movable closer or farther away from the wafer plane.

23. The furnace as defined by claim 19 the wherein the flow controller is configured to increase the flow of fluid from the source and toward the gas jet if a growing wafer has a thickness that is less than a first value.

24. The furnace as defined by claim 19 the wherein the flow controller is configured to decrease the flow of fluid from the source and toward the gas jet if a growing wafer has a thickness that is greater than a second value.

25. The furnace as defined by claim 24 wherein the pre-set value is between about 250 microns and 350 microns.
